(19) United States
(12) Patent Application Publication
(10) Pub. No.: US 2012/0005182 A1
(43) Pub. Date: Jan. 5, 2012

(54) METHODS AND SYSTEMS FOR SEARCH ENGINE RESULTS BASED ON DYNAMIC EXPERIENTIAL USAGE BY USERS

(76) Inventor: Dante Monteverde, Barrington Hills, IL (US)

(21) Appl. No.: 12/827,725

(22) Filed: Jun. 30, 2010

(51) Int. Cl. G06F 17/30

(52) U.S. Cl. 707/706; 707/E17.108

(57) ABSTRACT

A search engine is disclosed that collects information relevant to search queries and to post search activity, such as following links of returned search results, to determine the appropriateness and quality of the links and results relative to the search queries. The search engine uses the collected information to dynamically and in some forms in real time update and alter the information regarding the search results. Thus, user behavior after the search results are delivered is used as a proxy for which search results are the most valid and useful for the user.

### FIELD OF THE INVENTION

The invention relates to search engines and, in particular, to search results of Internet-based search engines wherein the search results are based on usage of specific links or results.

### BACKGROUND

Currently, one of the highest-valued Internet or Web-based utilities is the basic search engine. Many of the largest Internet-only companies rely on search activity to generate their largest amount of traffic and, thus, revenues.

There are many methods for producing a set of search results from a query input to a search engine, typically via an interface of a web browser. For the sake of convenience, the individual entries in the set of results are referred to as links herein. Some of these methods are proprietary, some are secret, some are simple, and others are quite complex. However, there are two basic manners in which the links are collected, those being through the use of specialized applications that seek out webpages (known as crawlers or spiders) and through manual input or identification of the links which often occurs by a website seeking to be included in a search engine's results. In the latter of these cases, the website operators may pay a fee in order to be in a section of sponsored links, or to receive a preferred ranking within the search result list.

In response to a query, the search results are displayed on the browser of the user who input the query. While the algorithms for various search engines may vary, a common manner for selecting the search results from the databases of the engine is for identifying the relevance of the search query to information contained in the webpage, such information previously having been collected. For instance, if a search query has a single word, the links produced by the engine would likely have a high usage of that word in the page to which the link directs.

Such engines are susceptible to manipulation by website operators. A website operator may generate revenue from advertising on the webpages of the website simply by virtue of hits or views of the webpage. Accordingly, an unscrupulous website operator may employ a variety of tactics to generate views of the webpage, regardless of whether the webpage is truly targeted by the user's search query.

As stated before, the engine collects information from the identified webpages. A portion of this information is legitimately related to the useful contents of the webpage, such that identification of website based on the search query is also useful to the searching user; however, some is not. The actual forms of worthless information, such as metatags or text that does not appear to a user (which can be done by reducing font size or by matching text color with background color, or by hiding the text behind a graphic), is not important. What is important is that such practices can result in a number of the links returned in response to a search query being based on this worthless information and, thus, the webpage is of little to no use to the searching user.

Accordingly, there has been a need for improved methods and systems with which to identify the validity and utility to actual users of search results provided by an Internet-based search engine as a result of a search query.

### SUMMARY

In accordance with an aspect, a web-based computer system search engine for receiving search queries and returning search results is disclosed including an input for a search query, the input displayed on a webpage of a browser provided at a remote computer by a user, a processor for receiving the search query from the user computer, a storage for storing correlated websites, links, and information relevant to the content of the websites, and a tracking application for collecting information, wherein the system produces a results webpage for display on the user computer in response to the search query, the results webpage including links listed according to a ranking of relevance to the search query, the tracking application collects information regarding search queries and user behavior in response to displayed search results, and the processor alters the information in the storage based on the user behavior.

In some forms, the tracking application is a software application stored on the user computer.

In some forms, the tracking application is opened for use when the browser is opened in the user computer.

In some forms, the system further includes an agreement by the user to have information collected.

In some forms, the collected information includes one or more of time spent on website corresponding to a link of the results webpage, a final website visited, subsequent visits to websites, and interaction between the user and a visited website.

In some forms, the system further includes an input provided to the user for actively providing feedback regarding one or more search results.

In some forms, the system collects information from a plurality of users, and the processor alters the information based on the aggregate of information collected.

In some forms, the processor alters the information in real time.

In another aspect, a method of dynamically ranking search results relative to a search query is disclosed including providing a search engine including a storage portion including information relevant to identified websites, and including a processing portion, displaying a search engine interface webpage on a user computer, providing a tracking application, receiving a search query from the user via the interface webpage, processing, via the processing portion, the search query to determine a ranked set of results from the storage portion, displaying at least a portion of the ranked set of results as a results webpage on the user computer, tracking and collecting information regarding user activity relative to the search query and the displayed search results, and altering the information in the storage portion relevant to the search results based on the user activity.

In some forms, the step of providing a tracking application includes forming an agreement with the user for information to be collected.

In some forms, the step of providing a tracking application includes installing a software application on the user computer.

In some forms, the step of providing a tracking application includes a user connecting to the search engine through a software application.

### BRIEF DESCRIPTION OF THE DRAWINGS

FIG. 1 is a representative view of a conventional web browser presented to a user on a computer monitor, the web browser displaying a search engine interface including an input box;

FIG. 2 is a representative view of the computer monitor and web browser of FIG. 1 displaying a set of search results in the web browser, the search results including a series of links, the search results being displayed in response to a particular search query;

FIG. 3 is a representative view corresponding to FIG. 2, the search results being displayed in response to the particular search query of FIG. 3 at a subsequent time; and

FIG. 4 is a graphical illustration of a system of the present invention.

### DETAILED DESCRIPTION

In general terms, the present invention utilizes a dynamic and evolving ranking system for determining search results to be displayed to users in response to a search query. More specifically, the present invention utilizes user behavior, after the search results are delivered, as a proxy for which search results are the most valid and useful for the user. In general, the invention is not concerned with how a search result was identified as an initial matter: that is, the invention seeks to remove the improperly returned search results while maintaining the appropriate results. Ultimately, the search results are objective-based, being displayed because users found the results to be useful, as opposed to the conventional approach of being based on text in titles and descriptions and backgrounds.

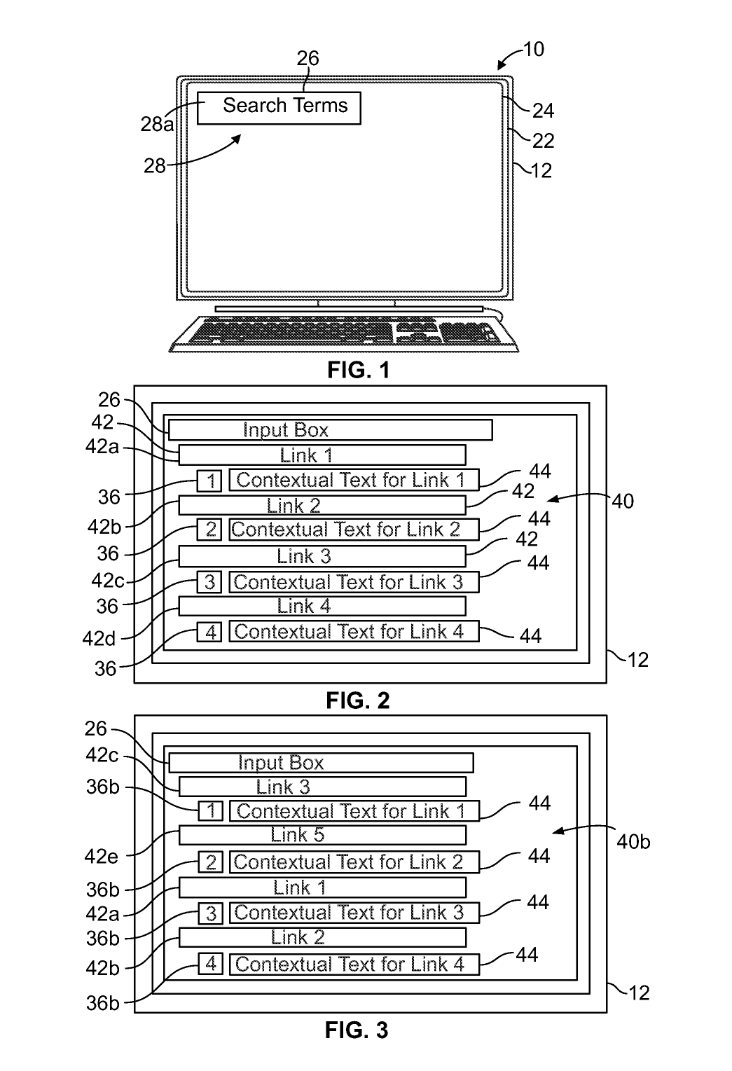

Referring initially to FIG. 1, a computer 10 including a monitor 12 is utilized by a user (not shown) to select a computer and web-based search engine 20, typically via a web browser 22. The search engine 20 responds by delivering a webpage in the form of a search page 24, the webpage being delivered as one or more computer files that are displayed in the browser 22 and on the monitor 12. The search page 24 has an input box 26 for receiving terms 28a of a search query 28. Such is a basic approach, and it is recognized that other forms may be used such as an input box in a toolbar of a webpage, by way of mere example.

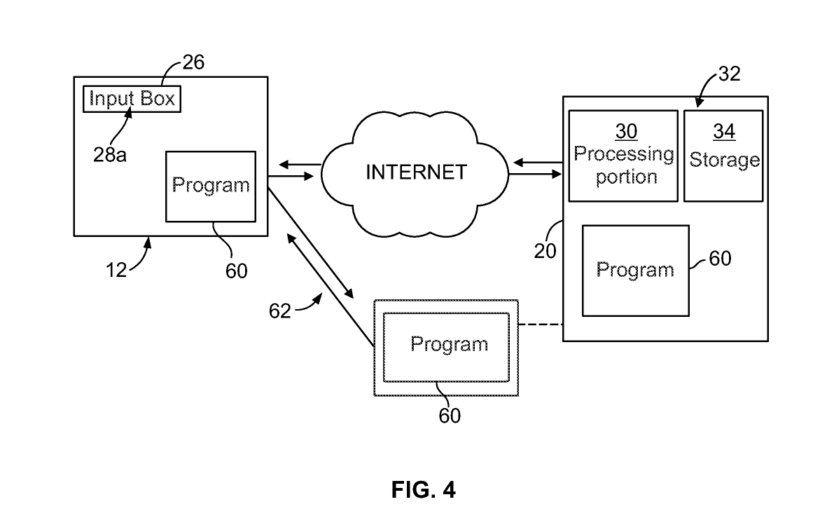

Turning to FIG. 4, the user inputs the terms 28a, as is conventionally known. The terms 28a are then transmitted (via the Internet, for example) to a processing portion 30 of the search engine 20. The search engine 20 includes one or more storage portions or databases 32 which have stored therein information 34 that has been collected as representative of various web pages and sites. The processing portion 30 compares the terms 28a to the information 34, thus resulting in both a list of sites that have information 34 that appears relevant to the terms 28a and a ranking 36 for each of those sites.

The search engine 20 returns a set 40 of results or links 42 to the browser 22 for display thereon. The set 40 may include a link or links 42a for sites determined to have information 34 that appears relevant and a link or links 42b for sites that have been purchased a high ranking or paid to be sponsor links. In most cases, the set 40 of results sent to the browser 22 is a subset of all the sites that may be relevant, such as the highest ranked search results. Upon subsequent request(s), a user may receive additional subsets of links that are lower-ranked than the previously displayed results.

FIG. 2 shows one such set 40 of links 42. Each link 42 may be paired with some text 44 from the webpage to which the link 42 directs so that the user can see the context in which the search terms 28a appear. The user typically considers this text 44 in deciding whether to follow a particular link 42 or not.

The present invention utilizes the user's activity after receiving search results to enhance the appropriateness of the set 40 of results, altering the results for a query, the information for a link or website, or both, in real time. That is, the search engine 20 tracks which links 42 are followed by the user. This tracking may include how many pages are viewed from the link 42, how long the pages are viewed, whether subsequent searches are made, whether there is interaction between the user and the site (such as ordering a product or transmitting information to the website such as through a fill-in form or an email), and a variety of other interactions that indicate the site was useful in response to the user's search query 28. A variety of known methods and applications may be used for tracking, such as cookies, java scripts, and browser frames, as a non-exhaustive list.

The search engine 20 uses this tracking information to revise the ranking of the results. That is, if a particular link 42 is never utilized or is immediately abandoned, the engine 20 recognizes that the link 42 and its associated page is not useful in response to the search query 28. Therefore, the link 42 will be dropped in ranking and the information 34 stored in the database may be appended or otherwise altered to reflect this drop. Conversely, selected links 42 for which tracking information indicates high level of usefulness to the user are raised in the overall rankings.

FIG. 2 may be compared with FIG. 3 to illustrate this dynamic shift in ranking. FIG. 2 shows search results 40, the first four links 42 according to ranking, returned in response to the search query 28. Accompanying each link 42 is the associated contextual text 44. In this representative view, a ranking score 36 is also displayed, though such need not be presented to the user and is presented here for illustrative purposes. FIG. 3 shows a set of results 40b at a subsequent time, four links 42 according to subsequent ranking scores 36b returned in response to the search query 28. As can be seen, link 42c has a higher ranking score 36 as result of user activity, and link 42d (FIG. 2) does not appear in FIG. 3 as it failed to gain user approval.

Additionally, link 42e appears for the first time in FIG. 3. Link 42e may be a link that was identified by a crawler of the engine 20 more recently than when the search of FIG. 2 was performed. Link 42e may also have been ranked out of the top results as they appeared in FIG. 2, yet has been promoted to the top based on user usage. Link 42e may also be a website identified by or to the operators of the engine 20, and the value of the link 42e is determined by the activity of real users, as described herein.

In still another form, another party may have paid for a high ranking for link 42e, such as an initial top-twenty listing. In this form, the search engine 20 can receive compensation in the same manner as the engine 20 would from traditional sponsor links. The operation of the engine 20 (i.e., the processing portion 30 acting on the information 34 in the storage portion 32) determines future rankings of all links 42, including sponsor links 42e. This pay-for-ranking feature is discussed in greater detail in concurrently-filed and co-pending U.S. Ser. No. __/____, the entirety of which is incorporated herein by reference.

In some forms, the engine 20 may operate under an established agreement with users. An agreement may be made between the operators of the engine 20 and users so that the users agree to provide information for the engine 20 to use in dynamically revising the information 34 so that the search results returned are improved. In one form, the agreement may entail users directly selecting which results (links 42) are best, directly ranking the links 42, and/or selecting which links 42 were inappropriate or should be dropped in ranking. Such is covered in greater detail in concurrently-filed and co-pending U.S. Ser. No. __/____, the entirety of which is incorporated herein by reference.

In another of these forms, the users agree to use of a software program 60 when searching, as can be seen in FIG. 4. In greater detail, the program 60 is to be running on the user's computer 10 prior to engaging in search activity. The user may run the program 60 by loading the program 60 from the engine 20 prior to each search and/or browser session, by loading the program 60 from a local drive (such as the hard drive of the computer 10) as an add-on to the browser 22, or may log on to a dedicated connection 62 (i.e., SSL) that hosts the program 60 the prior to and/or concurrent with utilizing the search engine 20.

When running, the program 60 collects all information relevant to the user's search activity including search terms, pages viewed from search results, amount of time spent viewing the pages, and the number of times a page is viewed. For instance, if a user finds a particular page useful, it is likely that the viewer will return in the future; therefore, it is preferred that the program 60 run whenever the user is engaged in internet activity so that subsequent uses of previously search-identified sites are recognized and collected by the program 60, each of which is illustrated concurrently in FIG. 4.

Other factors may be considered in determining the dynamic ranking of a particular link 42. One factor may be the number of successes for the link 42, which may be defined as the number of times a user ceased looking at other results after viewing the link 42. Another factor may be the number of times the link 42 was determined to be an inappropriate result by users. These factors may be correlated to the number of days that the link 42 was ranked above a certain cut-off (such as the top two pages of returned results), or the days since being collected into the storage portion 32. In some forms, the program 60 may allow the user to provide individual comments regarding advantages or disadvantages of a website, regarding prices (such as one that may indicate a high or low shipping cost for a particular retailer), or regarding other thoughts. Preferably, the program 60 includes ranking.com rankings for comparison by the user, a trust gauge, a cut-and-paste window, the ability to sort search results by location (such as “bookstore” as a search term and a zipcode for sorting or proximity to a location).

It is also contemplated that the user be provided with the ability to update or revise their rankings at a subsequent time, after additional experience has been gained. As examples, the search engine 20 or the program 60 may provide a link or a pop-up window that facilitates such feedback, and such may also be provided immediately after the user leaves a website that was identified as a link 42 in the search results 40.

In the preferred form, the users who agree to be tracked are selected based on a belief in their honesty. In order to prevent an unscrupulous website operator to shill the website, the users are preferably registered and identified. Validation of the users may include validating contact information, and a requirement of a minimum number of searches completed before the user's results are considered for overall use. Moreover, the user's feedback and activity is compared to the statistical means so outliers are identified. Additionally, an alert system can be implemented that watches a user's feedback to notify engine administrators to check on the user's activity, such as sudden changes to specific search terms or too many changes to specific search terms. The alert system may flag a registered user if multiple searches are run for the same or for similar search terms, the user repeatedly selecting the same result.

Users may be incentivized. While much of the technology community is collaborative and somewhat altruistic, it is believed that the possibility of a personal benefit to users may assist in producing a better search engine 20. That is, providing either a pecuniary reward or a chance at a giveaway is believed to encourage people to be responsible and diligent in providing the experiential feedback to the engine 20.

On the other hand, users may also be charged for using the engine 20. That is, while casual search users may not be interested, there are many search users with tremendous demand on search engines and who spend their entire days running search queries. These power-searchers need greater efficiency and would likely pay a fee for the opportunity to use the engine 20 as it has already improved the search results, thus reducing wasted time for the power-searcher.

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

1. A web-based computer system search engine for receiving search queries and returning search results, the system comprising:
an input for a search query provided by a webpage that is displayable on a browser provided at a remote computer by a user;
a processor for receiving the search query from the remote computer and for producing a results webpage for display on the remote computer in response to the search query, the results webpage including a plurality of links associated with respective webpages having content and listed according to a ranking of relevance to the search query,
a storage for storing the websites, links, and information relevant to the content of the websites in response to the user selecting one of the links, causing the delivery of the webpage associated with the link to the remote computer; and
a tracking application for collecting information regarding user behavior in response to displayed search results, wherein the user behavior includes at least one of (1) whether a subsequent search is made by the user after viewing the webpage associated with the link selected by the user, (2) whether the user orders a product from the webpage associated with the link selected by the user, and (3) whether the user enters information into a form on the webpage associated with the link selected by the user;
wherein the processor alters the information in the storage for at least one link in the results based on the user behavior.

2. (canceled)

3. The system of claim 1 wherein the tracking application is initiated when the browser is opened in the remote computer.

4. The system of claim 1 wherein the processor obtains the information in the storage based on an agreement by the user to have information collected.

5. (canceled)

6. The system of claim 1 further comprising an input accessible by the user allowing the user to actively provide feedback regarding one or more of the search results.

7. The system of clam 1 wherein the processor collects the information from a plurality of users and alters the information based on the aggregate of information collected.

8. The system of claim 1 wherein the processor alters the information in real time.

9. A method of dynamically ranking search results relative to a search query, the method including the steps of:
providing a search engine including a storage portion that stores information relevant to identified websites;
displaying a search engine interface webpage on a user computer;
receiving a search query from the user via the interface webpage;
processing, with a processor, the search query to determine a ranked set of results from the storage portion;
displaying at least a portion of the ranked set of results as a results webpage on the user computer, the results webpage including a plurality of links associated with respective webpages;
receiving from the user selected links;
tracking and collecting information regarding user behavior on the user computer with a tracking application; and
altering the information in the storage portion relevant to the search results based on at least one of (1) whether a subsequent search is made by the user after viewing the webpage associated with the link selected by the user, (2) whether the user orders a product from the webpage associated with the link selected by the user, and (3) whether the user enters information into a form on the webpage associated with the link selected by the user.

10. The method of claim 9 wherein the steps of tracking and collecting include forming an agreement with the user for information to be collected.

11. (canceled)

12. (canceled)
